(19) United States
(12) Patent Application Publication
(10) Pub. No.: US 2007/0072502 A1
(43) Pub. Date: Mar. 29, 2007

(54) Non-coated fabric for outdoor applications

(75) Inventors: Joey K. Underwood, Greenville, SC (US); Jacques Cantin, Greenville, SC (US)

Correspondence Address: DORITY & MANNING, P.A., POST OFFICE BOX 1449, GREENVILLE, SC, 29602-1449, US

(73) Assignee: Safety Components Fabric Technologies, Inc.

(21) Appl. No.: 11/588,053

(22) Filed: Oct. 26, 2006

Related U.S. Application Data
(63) Continuation-in-part of application No. 11/035,050, filed on Jan. 13, 2005.

(51) Int. Cl. B32B 27/12; B32B 27/04

(52) U.S. Cl. 442/82; 442/136; 442/79; 442/181; 442/123

(57) ABSTRACT

The present disclosure is directed toward a non-coated fabric for outdoor applications that is made up of a woven fabric and a chemical composition impregnated into the woven fabric. The woven fabric is made from multifilament yarns that are solution dyed and have a UV rating of at least 500 hours. The chemical composition includes a fluorocarbon polymer, a water repellent agent, a blocked isocyanate extender, and a fire resistant agent.

### CROSS-REFERENCE TO RELATED APPLICATIONS

The present application is a continuation-in-part of U.S. patent application Ser. No. 11/035,050 having a filing date of Jan. 13, 2005.

### BACKGROUND

Fabrics that are appropriate for use in outdoor applications must be durable and must be able to withstand weather conditions and other harsh conditions to which they are often subjected. In designing a fabric for use in outdoor applications, it is important to look at factors including hydrostatic pressure and UV resistance properties. In addition, factors such as appearance, breathability, dimensional stability, abrasion resistance, mark off resistance, and ease of fabrication are also very important. For various applications, fire resistance is also of importance. Environmental considerations are important as well.

In the past, the water resistant properties of fabrics used in outdoor applications were improved primarily by utilizing various coatings on the fabric. However, coated fabrics are not breathable. In addition, heavy coating on one side of the fabric causes water vapors to be trapped on the uncoated side of the fabric leading to the formation of mildew. Coated fabrics also lack the appearance of and are more costly to produce than non-coated fabrics.

While more breathable, existing non-coated fabrics have high mark off, poor abrasion resistance, and poor dimensional stability. In addition, current non-coated fabrics have poor hydrostatic pressure, poor UV resistance, and lack fire resistant capability. Thus, a need exists for non-coated fabrics for use in outdoor applications that have improved air permeability, improved mark off, improved abrasion resistance, and improved dimensional stability. In addition, a need exists for non-coated fabrics having improved hydrostatic pressure, improved UV resistance, and fire resistant capability.

### SUMMARY

Objects and advantages of the disclosure will be set forth in part in the following description, or may be obvious from the description, or may be learned through the practice of the disclosure.

The present disclosure is directed toward a non-coated fabric for outdoor applications that is made up of a woven fabric and a chemical composition impregnated into the woven fabric. The woven fabric is made from multifilament yarns that are solution dyed and have a UV rating of at least 500 hours. The chemical composition includes a fluorocarbon polymer, a water repellent agent, a blocked isocyanate extender, and a fire resistant agent.

In some embodiments, the multifilament yarns can be chosen from a group that includes polyester, nylon, polypropylene, polyethylene, polytetrafluoroethylene, and mixtures thereof. In some embodiments, the non-coated fabric can have fluorocarbon present in the chemical composition from about 1 percent to about 20 percent by weight. In some embodiments, the non-coated fabric can have water repellent agent present in the chemical composition from about 0.1 percent to about 10 percent by weight. In some embodiments, the non-coated fabric can have blocked isocyanate extender present in the chemical composition from about 0.1 percent to about 5 percent by weight. In some embodiments, the non-coated fabric can have fire resistant agent present in the chemical composition from about 5 percent to about 15 percent by weight. In certain embodiments, the non-coated fabric can have a UV rating of at least 1000 hours or at least 1500 hours. In some embodiments, the non-coated fabric can have a basis weight of from about 3 to about 10 ounces per square yard. In certain embodiments, the chemical composition can include a wetting agent. In some embodiments, the chemical composition can include an antimicrobial agent. In certain embodiments, the fabric can be used in the construction of an outdoor product chosen from the group including awnings, tents, casual outdoor furniture, umbrellas, covers, canopies, and banners.

In another exemplary embodiment, a woven fabric is made from multifilament yarns that are solution dyed and have a UV rating from about 500 hours to about 1500 hours. A chemical composition is impregnated into the woven fabric and includes from about 1 percent to about 20 percent by weight of fluorocarbon polymer, from about 0.1 percent to about 10 percent by weight of water repellent agent, from about 0.1 percent to about 5 percent by weight of blocked isocyanate extender, and from about 5 percent to about 15 percent by weight of cyclic phosphonate.

Other features and aspects of the present disclosure are discussed in greater detail below.

Definitions and Standardized Procedures

The following definitions and procedures are offered in order to better describe and quantify the performance fabrics made according to the present disclosure.

Thickness Test

The thickness test measures the thickness of the fabric. The test is known in the art and conforms to ASTM D 1777—96 (Reapproved 2002). The results are expressed in millimeters.

A fabric is placed on the base of a thickness gage and a weighted presser foot is lowered. The displacement between the base and the presser foot is measured as the thickness of the fabric.

Water Repellency: Spray Test

The spray rating test measures the resistance of fabrics to wetting by water. The test is known in the art and conforms to AATCC 22-1996. The results are expressed on a scale of 0 to 100 with 0 indicating a complete wetting of whole upper and lower surfaces and 100 indicating no sticking or wetting of the upper surface.

Water sprayed against the taut surface of a test specimen under controlled conditions produces a wetted pattern whose size depends on the relative repellency of the fabric. Evaluation is accomplished by comparing the wetted pattern with pictures on a standard chart.

Air Permeability

Air permeability can be used to provide an indication of the breathability of weather resistant and rainproof fabrics. The air permeability test is known in the art and conforms to ASTM D 737—96. The results are expressed in cubic feet/square feet minute (cfm).

The rate of air flow passing perpendicularly through a known area of fabric is adjusted to obtain a prescribed air pressure differential between the two fabric surfaces. From this rate of air flow, the air permeability is determined.

Water Resistance: Hydrostatic Pressure Test

The hydrostatic pressure test measures the resistance of a fabric to the penetration of water under hydrostatic pressure. The test is known in the art and conforms to AATC 127—1998. The results are expressed in cm H2O.

One surface of the test specimen is subjected to a hydrostatic pressure, increasing at a constant rate, until three points of leakage appear on its other surface. The water may be applied from above or below the test specimen.

Stiffness of Fabric by the Circular Bend Procedure

The circular bend procedure gives a force value related to fabric stiffness, simultaneously averaging stiffness in all directions. The test is known in the art and conforms to ASTM D 4032—94 (Reapproved 2001).

A plunger forces a flat, folded swatch of fabric through an orifice in a platform. The maximum force required to push the fabric through the orifice is an indication of the fabric stiffness (resistance to bending).

Breaking Strength and Elongation of Textile Fabrics (Grab Test)

The grab tensile test used herein measures breaking strength of a fabric when subjected to unidirectional stress. This test is known in the art and conforms to ASTM D 5034—95 (Reapproved 2001). The results are expressed in pounds to break. Higher numbers indicate a stronger fabric. The values noted herein, measured in pounds, represent the “load” or the maximum load or force, expressed in units of weight, required to break or rupture the specimen in a tensile test.

The grab tensile test uses two clamps, each having two jaws with each jaw having a facing in contact with the fabric sample. The clamps hold the fabric in the same plane, usually vertically, separated by approximately three inches and move apart at a specified rate of extension. The sample is wider than the clamp jaws to give results representative of effective strength of yarns in the clamped width combined with additional strength contributed by adjacent yarns in the fabric. Usually, a grab tensile strength test closely simulates fabric stress conditions in actual use. Results are reported as an average of three specimens and may be performed with the specimen in the cross direction or the machine direction.

Tearing Strength of Fabrics by the Tongue (Single Rip) Procedure

Tear strength, as measured in this test method, requires that the tear be initiated before testing. The reported value obtained is not directly related to the force required to initiate or start of a tear. The test method used is known in the art and conforms to ASTM D 2261—96 (Reapproved 2002).

A rectangular specimen, cut in the center of a short edge to form a two-tongued (trouser shaped) specimen, in which one tongue of the specimen is gripped in the upper jaw and the other tongue is gripped in the lower jaw of a tensile testing machine. The separation of the jaws is continuously increased to apply a force to propagate the tear. At the same time, the force developed is recorded. The force to continue the tear is calculated from autographic chart recorders or microprocessor data collection systems.

Abrasion Resistance of Textile Fabrics (Rotary Platform, Double-Head Method)

The abrasion cycle is dependent on the programmed motions of the abrasion machine and the test standard used. It may consist of one back and forth unidirectional movement such as for the rotary platform test method. The test method used is known in the art and conforms to ASTM D 3884—01.

A specimen is abraded using rotary rubbing action under controlled conditions of pressure and abrasive action. The test specimen, mounted on a platform, turns on a vertical axis, against the sliding rotation of two abrading wheels. One abrading wheel rubs the specimen outward toward the periphery and the other, inward toward the center. The resulting abrasion marks form a pattern of crossed arcs over an area of approximately 30 cm².

Ultraviolet Rating Test

Two methods are used to determine ultraviolet rating. The accelerated exposure test is designed to accelerate extreme environmental conditions encountered due to sunlight, heat, and moisture for the purpose of predicting the performance of materials. The test method used is known in the art and conforms to SAE J1960. The colorfastness to light test tests the resistance of a material to a change in its color characteristics as a result of exposure of the material to sunlight or an artificial light source. The test methods used are known in the art and conform to AATC Test Method 169—2003 revision Xenon light and AATC Test Method 186—2001 revision Pure UV exposure.

Flame Propagation Test

The flame propagation test is used to assess the propagation of flame beyond an area exposed to an ignition source. The test method used is known in the art and conforms to NFPA 701—2004 Edition Test Method 1 and 2.

A weighed specimen consisting of one or more layers of textile is suspended vertically from a pin bar near the top rear of an open-face test cabinet. A specified gas flame is applied to the center of the lower edge of the specimen for 45 seconds and then withdrawn. The specimen is allowed to burn until the flame self-extinguishes and there is no further specimen damage. The specimen is then removed from the pin bar and, after room conditioning, is weighed again. The percent weight loss is determined and used as a measure of total flame propagation and specimen damage.

### BRIEF DESCRIPTION OF THE DRAWINGS

A full and enabling disclosure of the present disclosure, including the best mode thereof to one of ordinary skill in the art, is set forth more particularly in the specification, including reference to the accompanying Figures in which:

FIG. 1 represents an awning in accordance with one embodiment of the present disclosure;

FIG. 2 represents a tent in accordance with one embodiment of the present disclosure;

FIG. 3 represents an umbrella in accordance with one embodiment of the present disclosure; and

FIG. 4 represents a piece of outdoor furniture in accordance with one embodiment of the present disclosure.

### DETAILED DESCRIPTION

It is to be understood by one of ordinary skill in the art that the present discussion is a description of exemplary embodiments only, and is not intended as limiting the broader aspects of the present disclosure, which broader aspects are embodied in the exemplary construction.

In general, the present disclosure is directed to a non-coated fabric suitable for outdoor applications that can have improved hydrostatic pressure, UV resistant properties, and fire resistant properties. In addition, the non-coated fabric can have improved air permeability, improved mark off, improved abrasion resistance, and improved dimensional stability. The non-coated fabric also protects from other outdoor elements such as visible light, infra-red heat, heat, organic particles, pollution residuals, bird droppings, and the like.

The non-coated woven fabric of the present disclosure has improved characteristics over both coated and non-coated fabrics in the art. As used herein, a coated fabric refers to a fabric in which a thickness of polymer is applied on at least one side of the fabric without impregnating the fabric. By contrast, a non-coated fabric refers to a fabric that is substantially impregnated with a treatment or contains no treatment. In particular, the present disclosure is directed to a non-coated woven fabric made from multifilament yarns. The multifilament yarns can provide greatly improved dimensional stability and abrasion resistance when compared to other non-coated fabrics. The multifilament yarns are solution dyed and enhanced with UV stabilizers so that the yarns and the fabric can have greatly improved UV resistance when compared to other coated fabrics. In this regard, UV stabilizers can include UV absorbers and the like. In addition, a chemical composition is applied to the fabric which can improve the resistance of the fabric to the penetration of water under hydrostatic pressure without the mark off typical of both coated and non-coated fabrics. The chemical composition can also improve air permeability over existing coated fabrics. Finally, the chemical composition allows for fire resistant capability.

Fabrics that are suitable for use in the process of the present disclosure may be manufactured with yarns made of nylon, polyester, polypropylene, polytetrafluoroethylene, polyethylene, mixtures thereof, and other similar yarns. For most applications, however, polyester is preferred. In one exemplary embodiment, SATURA yarns are utilized which are commercially available from Unifi, Inc. The SATURA yarns are solution dyed with specialty pigments commercially available from American Colors. In addition, UV stabilizers are added to the yarns. In a solution dyed yarn, pigments and UV stabilizers are added while the yarn is still in a liquid state. In some embodiments, the UV stabilizer utilized is SATURAMAX UV absorber which is commercially available from Unifi, Inc. The components become part of the fibers and resist fading or washing out.

It has also been found that UV resistance can be greatly increased using such yarns. In some embodiments, the UV rating of the fabrics is at least 500 hours. In some embodiments, the UV rating of the fabrics is from about 500 hours to about 1500 hours. In some embodiments, the UV rating of the fabrics is at least 1000 hours. In still other embodiments, the UV rating of the fabrics is at least 1500 hours. In some embodiments, the UV rating of the fabrics is from about 500 hours to about 1500 hours. In some embodiments, the UV rating of the fabrics is from about 500 hours to about 1200 hours. And in still other embodiments, the UV rating of the fabrics is from about 500 hours to about 1000 hours. High UV resistance characteristics in fabrics are important for color and strength retention.

The yarns used in the fabric of the present disclosure may be woven into various constructions. A particular weave may be selected to provide durability, stability, breathability, and ease of fabrication. For instance, it is preferable that the fabric of the present disclosure have an ottoman weave or a plain weave. Any other suitable weave may be employed, for example such as a ripstop weave or a twill weave. However, it is important the fabric maintain a balance of stiffness for ease of cutting and softness for ease of contouring on a particular outdoor product.

The weight of the fabric made in accordance with the present disclosure can vary and generally will depend upon the particular application for which the fabric is used. However, the fabric made in accordance with the present disclosure can have improved characteristics over the prior art fabrics with a lower weight (ounce per yard). The fabric is designed to withstand inconsistent and repetitive loads with high dynamic forces like wind gusts, heavy rain, air pressure, and the like. For most applications, the fabric can have a weight of from about 3 ounces per square yard to about 10 ounces per square yard, and particularly from about 5.5 ounces per square yard to about 8.5 ounces per square yard. In general, the yarns used to construct the fabric are multifilament yarns, although it is believed that monofilament yarns may be used in some applications. The denier of the yarns again will vary depending upon the type of product being formed with the fabric. In general, however, the denier of the yarns can be from about 150 to about 900. It may also be desirable to texturize multifilament yarns with air jet texturing or plying.

When using yarns within the above described denier ranges, the woven fabric of the present disclosure can have from about 30 ends to about 100 ends per inch, which refers to the warp yarn density. More particularly, the fabric can have from about 80 to about 100 ends per inch. The number of picks, which refers to the fill yarn density, on the other hand, can generally vary from about 40 picks per inch to about 80 picks per inch. In the fill direction, 76 picks per inch is preferable when using an ottoman weave while 50 picks per inch is preferable when a plain weave is utilized.

In accordance with the present disclosure, the exterior surface of the fabric includes a chemical composition. The chemical composition applied to the fabric in accordance with the present disclosure has been found to provide excellent water resistance capabilities. It was also discovered that the chemical composition significantly improves the breathability of the fabric when compared to coated fabrics. As discussed above, when applied according to the present disclosure, it has been determined that the finish is very abrasion resistant. The fabric is also resistant to chemicals for ease of cleaning.

In one embodiment of the present disclosure, the chemical composition is made from a solution of a fluorocarbon polymer that is applied to the fabric. For example, the chemical composition can be made from GLO-CRYL AWX 3 which is commercially available from Glo-Tex Chemicals, Inc. Fluorocarbon polymer solutions are also commercially available from other numerous sources and suitable for use herein.

Besides containing a fluorocarbon polymer, the chemical composition can also contain various other additives.

For instance, in one embodiment, the chemical composition can include a water repellent agent. In some embodiments, Phobotex JVA, commercially available from Huntsman International, LLC as an emulsion of paraffin wax and melamine resin, is utilized as a suitable water repellent agent. Other commercially available water repellent agents are also available from other sources and are suitable for use herein.

In addition, the chemical composition can also include an extender to promote durability. In some embodiments, a blocked isocyanate extender can be utilized. In some embodiments, the blocked isocyanate extender is added after copolymerization (i.e., as a blended isocyanate). An example of a suitable blocked isocyanate is HYDROPHOBOL XAN available from Huntsman International, LLC. In accordance with the present disclosure, it has been determined that a blocked isocyanate extender can be benefically combined with a paraffin wax and melamine resin water repellent agent to impart desirable characteristics to the non-coated fabric described herein. Other commercially available blocked isocyanates are also suitable for use herein.

In one embodiment of the present disclosure, the chemical composition can include a flame retardant composition. The flame retardant can be selected from a variety of suitable flame retardant compounds including phosphorous compounds, such as cyclic phosphonates. An example of a suitable flame retardant is PYROVATEX SVC which is commercially available from Huntsman International, LLC. However, any other suitable flame retardant compounds may also be utilized. The flame retardant compound serves to make the fabric fire resistant. A fire resistant fabric is noncombustible and non conductive and can be utilized where flammability is a concern.

In this regard, a difficulty in achieving fire resistance with non-coated fabrics while maintaining suitable water resistance performance is that the fire resistance components typically do not permit a fluorocarbon polymer to satisfactorily bond with the fabric in comparison. As described above, paraffin wax and melamine resin water repellent agent components can assist to fill in the fabric pores to help resist water pressure. Still, because fluorocarbon polymer can have a tendency to burn, the weight percentages of fluorocarbon polymer and fire resistant agent as described herein is important in maintaining the fire resistance of the fabric.

Additionally, the chemical composition can contain an antimicrobial agent. The antimicrobial agent serves to help make the fabric mildew resistant. Any suitable antimicrobial agents known in the art can be utilized. In some embodiments, the chemical composition can contain a wetting agent such as isopropyl alcohol.

In one embodiment, the chemical composition can contain from about 1 percent to about 20 percent by weight of a fluorocarbon polymer composition, and particularly from about 2 percent to about 10 percent by weight of the bath. The chemical composition can contain from about 0.1 percent to about 10 percent by weight of water repellent agent and more particularly from about 2 percent to about 5 percent by weight. The chemical composition can contain from about 0.1 percent to about 5 percent by weight of extender and more particularly from about 1 percent to about 3 percent by weight. The chemical composition can contain from about 1 percent to about 20 percent by weight of fire resistant agent and more particularly from about 5 percent to about 15 percent by weight. Further, the chemical composition can contain an antimicrobial and a wetting agent in an amount from about 0.1 percent to about 5 percent by weight, and particularly from about 0.1 percent to about 1 percent by weight of the bath.

In order to produce a liquid resistant fabric in accordance with the present disclosure, after the woven fabric is constructed, the fabric can first be scoured, although scouring may not be necessary for all applications. After scouring, the fabric will be dried.

After these processing steps, a chemical composition according the present disclosure is supplied to both sides of the fabric. Although the treatment can be applied by plasma treatment, sprayed on the fabric, or printed on the fabric, preferably the fabric is dipped into a bath containing the chemical composition in solution form wherein the chemical composition is not coated on the fabric but rather substantially impregnated on the fabric.

In one embodiment, the composition is applied to the fabric at a wet pick up rate of from about 10% to about 50% by weight of the fabric, particularly from about 20% to about 25% by weight.

After the chemical composition is applied to the fabric, the fabric is then heated to a temperature sufficient for the finish to dry and/or cure. The fabric must be dimensionally stable to withstand heat during processes. In one particular embodiment, the finish may be cured by heating the fabric to a temperature of about 360° F. for approximately 20-25 seconds. In some embodiments, after curing the finish, the fabric is passed through a calender under at least 1000 psi to help reduce the mark off of the fabric. Once the chemical composition is cured and affixed to the woven fabric, the fabric can then be used in constructing materials for outdoor applications.

As stated previously, the non-coated fabric of the present disclosure can improve hydrostatic pressure, UV resistance, and fire resistance of fabrics. In addition, the non-coated fabric can have improved air permeability, improved mark off, improved abrasion resistance, and improved dimensional stability. Such resistance is of importance in fabrics for outdoor applications.

Preferred embodiments of the present disclosure involve the use of the fabric in the construction of materials for outdoor applications. Items that benefit from improved hydrostatic pressure and UV resistance may be constructed from the fabric described herein. For example, automotive and marine applications, awnings, casual outdoor furniture, tents, umbrellas, covers, canopies, banners, military applications, and the like may be constructed using the fabric of the present disclosure. Additionally, many items benefit from the fire resistant capabilities of the fabric of the present disclosure. Such items can include, without limitation, indoor or outdoor awnings, tents, canopies, umbrellas, casual outdoor furniture, and the like.

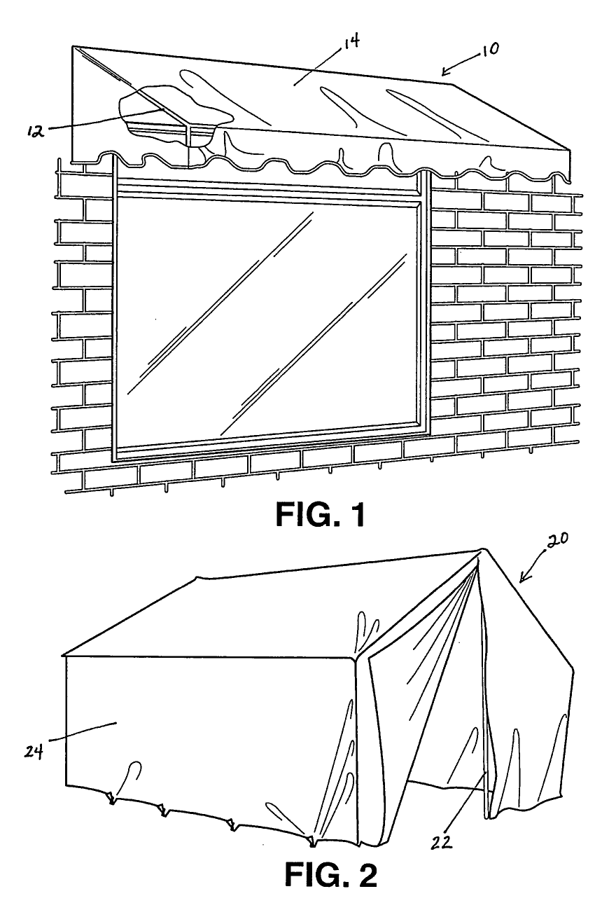

With reference to FIG. 1, an outdoor awning 10 is illustrated. The awning includes a frame 12 which can be attached to a structure. The frame 12 is covered by fabric 14 as described in the present disclosure.

Referring to FIG. 2, a tent 20 is illustrated. The tent 20 includes a frame structure 22. The frame structure 22 can be formed by poles or the like. The frame structure 22 is covered by fabric 24 as described in the present disclosure.

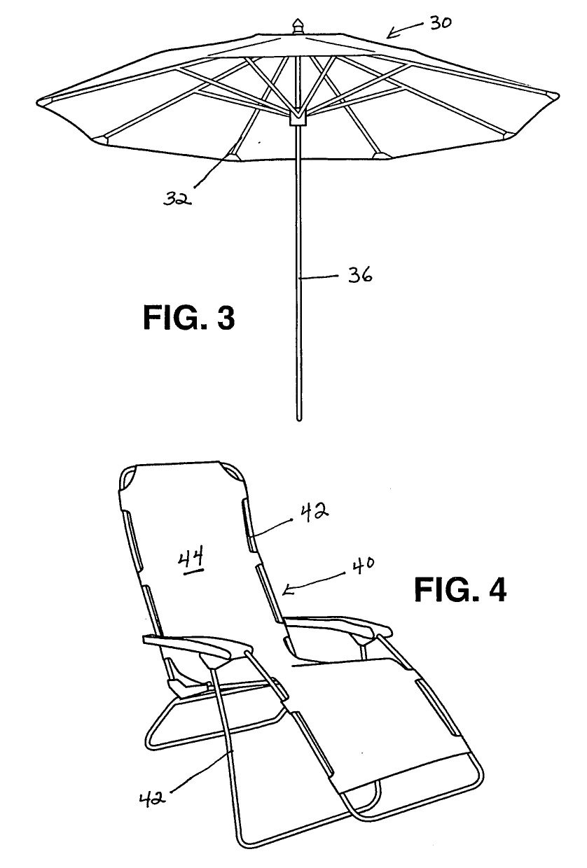

With reference to FIG. 3, an umbrella 30 is illustrated. The umbrella 30 includes a frame 32. The frame 32 can extend outward from a central shaft 36.

The frame 32 is covered by fabric 34 as described in the present disclosure.

Finally, with reference to FIG. 4, a piece of outdoor furniture is illustrated, specifically a folding chair 40. The folding chair 40 includes support elements 42. The support elements 42 are covered by fabric 44 as described in the present disclosure. It should be understood that the fabric may include padding or cushioning as would be known in the art.

The advantages of the present disclosure over coated fabrics in the prior art may be better understood with reference to the following Example 1:

| | | Odyssey | | Sample 1 | Sample 2 | Sample 3 |
|---|---|---|---|---|---|---|
| | Top Gun | III | SurLast | (non- | (non- | (non- |
| Name | (coated) | (coated) | (coated) | coated) | coated) | coated) FR |
| Company | Marchem | Marchem | Glen | Safety | Safety | Safety |
| | | | Raven | Components | Components | Components |
| Construction | 116 × 72 | 62 × 43 | 43 × 31 | 95 × 74 | 95 × 50 | 95 × 74 |
| Weave | 2 × 2 | Plain | Plain | Ottoman | Plain | Ottoman |
| | Basket | | | | | |
| Weight | 11.3 | 6.2 | 7.4 | 8.0 | 6.5 | 8.2 |
| (oz/yd) | | | | | | |
| Air | 0.02 | 0.05 | 0.11 | 1.30 | 1.40 | 1.00 |
| Permeability | | | | | | |
| Hydrostatic | 83 | 20 | 59 | 65 | 50 | 50 |
| Pressure | | | | | | |
| (cm) | | | | | | |
| Grab | 621 | 302 | 410 | 480 | 460 | 480 |
| Strength | | | | | | |
| Warp (lb) | | | | | | |
| Grab | 414 | 226 | 286 | 390 | 270 | 390 |
| Strength | | | | | | |
| Filling (lb) | | | | | | |
| UV Rating | 1000 | 1000 | 600 | 1500 | 1500 | 1500 |

The advantages of the present disclosure over non-coated fabrics in the prior art may be better understood with reference to the following Example 2:

| | Sunbrella | Sample 1 | Sample 2 | Sample 3 |
|---|---|---|---|---|
| | (non- | (non- | (non- | (non- |
| Name | coated) | coated) | coated) | coated) FR |
| Company | Glen | Safety | Safety | Safety |
| | Raven | Components | Components | Components |
| Construction | 77 × 36 | 95 × 74 | 95 × 50 | 95 × 74 |
| Weave | Plain | Ottoman | Plain | Ottoman |
| Weight | 9.0 | 8.0 | 6.5 | 8.2 |
| (oz/yd) | | | | |
| Hydrostatic | 39 | 65 | 50 | 50 |
| Pressure | | | | |
| (cm) | | | | |
| Grab | 365 | 480 | 460 | 480 |
| Strength | | | | |
| Warp (lb) | | | | |
| Grab | 212 | 390 | 270 | 390 |
| Strength | | | | |
| Filling (lb) | | | | |
| Tongue | 13 | 17 | 12 | 17 |
| Tear | | | | |
| Strength | | | | |
| Warp (lb) | | | | |
| Tongue | 9 | 20 | 10 | 20 |
| Tear | | | | |
| Strength | | | | |
| Filing (lb) | | | | |
| Taber | 90 | 600 | 400 | 600 |
| Abrasion | | | | |
| (Cycles to | | | | |
| 1^{st} hole) | | | | |
| UV Rating | 1500 | 1500 | 1500 | 1500 |

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed is:

1. A non-coated fabric having fire resistant capabilities comprising:
a woven fabric, said woven fabric being made from multifilament yarns, said yarns being solution dyed, said yarns having a UV rating of at least 500 hours; and
a chemical composition impregnated into to said woven fabric, said chemical composition comprising a fluorocarbon polymer, a water repellent agent, a blocked isocyanate extender, and a fire resistant agent.

2. A non-coated fabric as in claim 1, wherein said multifilament yarns are chosen from the group comprising polyester, nylon, polypropylene, polyethylene, polytetrafluoroethylene, and mixtures thereof.

3. A non-coated fabric as in claim 1, wherein said fluorocarbon is present in said chemical composition from about 1 percent to about 20 percent by weight.

4. A non-coated fabric as in claim 1, wherein said water repellent agent is present in said chemical composition from about 0.1 percent to about 10 percent by weight.

5. A non-coated fabric as in claim 1, wherein said blocked isocyanate extender is present in said chemical composition from about 0.1 percent to about 5 percent by weight.

6. A non-coated fabric as in claim 1, wherein said fire resistant agent is present in said chemical composition from about 5 percent to about 15 percent by weight.

7. A non-coated fabric as in claim 1, wherein said woven fabric has a UV rating of at least 1500 hours.

8. A non-coated fabric as in claim 1, wherein said woven fabric has a basis weight of from about 3 to about 10 ounces per square yard.

9. A non-coated fabric as in claim 1, wherein said chemical composition further comprises a wetting agent.

10. A non-coated fabric as in claim 1, wherein said chemical composition further comprises an antimicrobial agent.

11. A non-coated fabric as in claim 1, wherein said fabric is used in the construction of an outdoor product, said outdoor product chosen from the group comprising awnings, casual outdoor furniture, umbrellas, tents, covers, canopies, and banners.

12. A non-coated fabric having fire resistant capabilities comprising:
a woven fabric, said woven fabric being made from multifilament yarns, said yarns being solution dyed, said yarns having a UV rating of from about 500 hours to about 1500 hours; and
a chemical composition impregnated into said woven fabric, said chemical composition comprising from about 1 percent to about 20 percent by weight of fluorocarbon polymer, from about 0.1 percent to about 10 percent by weight of water repellent agent, from about 0.1 percent to about 5 percent by weight of blocked isocyanate extender, and from about 5 percent to about 15 percent by weight of cyclic phosphonate.

13. A non-coated fabric as in claim 12, wherein said water repellent agent comprises an emulsion of paraffin wax and melamine resin.

14. A non-coated fabric as in claim 12, wherein said woven fabric has a UV rating from about 500 hours to about 1200 hours.

15. A non-coated fabric as in claim 12, wherein said woven fabric has a UV rating from about 500 hours to about 1000 hours.

16. A non-coated fabric as in claim 12, wherein said woven fabric has a basis weight of from about 5.5 to about 8.5 ounces per square yard.

17. A non-coated fabric as in claim 12, wherein said woven fabric has an ottoman weave.

18. A non-coated fabric as in claim 12, wherein said woven fabric has a plain weave.

19. A non-coated fabric as in claim 12, wherein said chemical composition further comprises an antimicrobial agent and a wetting agent.

20. A non-coated fabric as in claim 12, wherein said yarn has a denier of from about 150 to about 900.

21. A non-coated fabric as in claim 12, wherein said fabric is used in the construction of an outdoor product, said outdoor product chosen from the group consisting of awnings, casual outdoor furniture, umbrellas, covers, canopies, and banners.
